(19) United States
(12) Patent Application Publication
(10) Pub. No.: US 2022/0149532 A1
(43) Pub. Date: May 12, 2022

(54) IMAGING DEVICE

(71) Applicant: SONY GROUP CORPORATION, TOKYO (JP)

(72) Inventor: HIDEKI SANO, TOKYO (JP)

(21) Appl. No.: 17/433,464

(22) PCT Filed: Feb. 18, 2020
(86) PCT No.: PCT/JP2020/006202

§ 371 Date: Aug. 24, 2021

(30) Foreign Application Priority Data
Mar. 7, 2019 (JP) 2019-041491

(51) Int. Cl. H01Q 13/10; H01Q 9/06; H04N 5/232; H01Q 1/12

(52) U.S. Cl. CPC H01Q 13/10; H01Q 1/125; H04N 5/23245; H01Q 9/06

(57) ABSTRACT

There is provided an electronic device that is able to perform wireless communication while having a simpler configuration. The imaging device includes an antenna including a first metal member, a second metal member, a first electrical conductor, a second electrical conductor, a first signal line, and a second signal line. The first metal member extends in a first direction. The second metal member extends in the first direction, and is opposed to the first metal member in a second direction with a gap interposed therebetween. The second direction is orthogonal to the first direction. The second direction is orthogonal to the first direction. The first electrical conductor couples the first metal member and the second metal member to each other in the second direction at a first position in the first direction. The second electrical conductor couples the first metal member and the second metal member to each other in the second direction at a second position away from the first position in the first direction. The first signal line is coupled to the first metal member at a third position between the first position and the second position in the first direction. The second signal line is coupled to the second metal member.

### TECHNICAL FIELD

The present disclosure relates to an electronic device including an antenna.

### BACKGROUND ART

There has been proposed a camera equipped with an antenna that performs wireless communication (for example, refer to PTLs 1 and 2).

### CITATION LIST

### Patent Literature

PTL 1: Japanese Unexamined Patent Application Publication No. 2006-217354

PTL 2: Japanese Unexamined Patent Application Publication No. 2007-82261

### SUMMARY OF THE INVENTION

Incidentally, downsizing of an electronic device like such a camera is desired.

It is therefore desirable to provide an electronic device that is able to perform wireless communication while having a simpler configuration.

An electronic device as an embodiment of the present disclosure includes an antenna including a first metal member, a second metal member, a first electrical conductor, a second electrical conductor, a first signal line, and a second signal line. The first metal member extends in a first direction. The second metal member extends in the first direction, and is opposed to the first metal member in a second direction with a gap interposed therebetween. The second direction is orthogonal to the first direction. The second direction is orthogonal to the first direction. The first electrical conductor couples the first metal member and the second metal member to each other in the second direction at a first position in the first direction. The second electrical conductor couples the first metal member and the second metal member to each other in the second direction at a second position away from the first position in the first direction. The first signal line is coupled to the first metal member at a third position between the first position and the second position in the first direction. The second signal line is coupled to the second metal member.

In the electronic device as the embodiment of the present disclosure, the antenna has a configuration described above, thereby becoming a slot antenna that includes a slot surrounded by the first metal member, the second metal member, the first electrical conductor, and the second electrical conductor.

### BRIEF DESCRIPTION OF DRAWINGS

FIG. 1A is a first perspective view of an appearance of an imaging device according to an embodiment of the present disclosure.

FIG. 1B is a second perspective view of an appearance of the imaging device illustrated in FIG. 1A as viewed from a different direction.

FIG. 2 is a block diagram illustrating a configuration example of functions of the imaging device illustrated in FIG. 1A.

FIG. 3A is a perspective view of an appearance of a mode dial illustrated in FIG. 1A.

FIG. 3B is a cross-sectional view of an inner configuration of the mode dial illustrated in FIG. 3A.

FIG. 3C is a conceptual diagram illustrating a configuration of the mode dial illustrated in FIG. 3A.

FIG. 3D is a schematic plan view of a configuration of the mode dial illustrated in FIG. 3A.

FIG. 4 is an enlarged cross-sectional view of a first terminal of a first coupling section illustrated in FIG. 3B.

FIG. 5 is an enlarged cross-sectional view of a first terminal of a first coupling section as a first modification example.

FIG. 6 is a conceptual diagram illustrating a configuration of a mode dial as a second modification example.

FIG. 7 is a perspective view of an appearance of an audio device as a modification example of the present disclosure.

### MODES FOR CARRYING OUT THE INVENTION

Some embodiments of the present disclosure are described below in detail with reference to the drawings. It is to be noted that the description is given in the following order.

### 1. Embodiment

An example of an imaging device in which an image shooting mode selecting operation section doubles as a slot antenna

### 2. Modification Examples

<1. Embodiment>

[1.1 Configuration of Imaging Device 100]

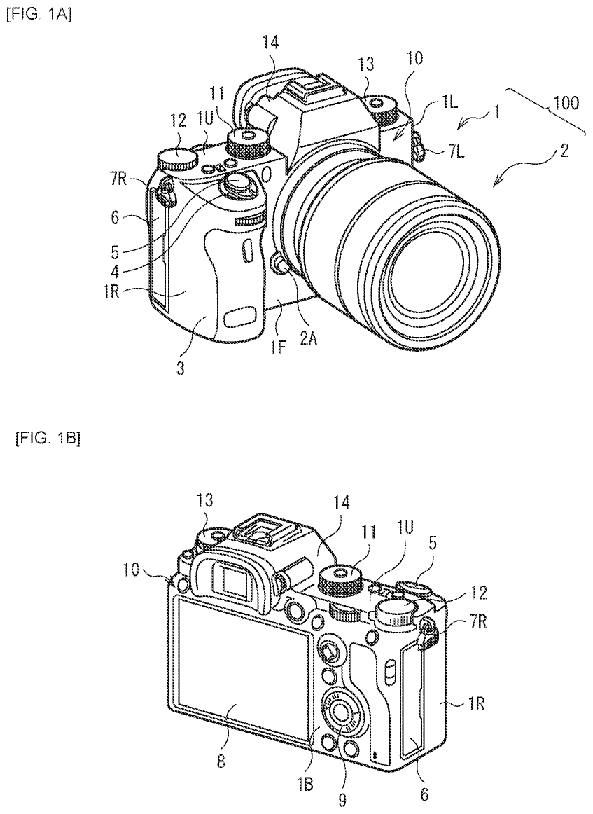

FIG. 1A is a perspective view of an appearance of an imaging device 100 as an electronic device according to an embodiment of the present technology as viewed diagonally from the front. FIG. 1B is a perspective view of an appearance of the imaging device 100 as viewed diagonally from the back.

As illustrated in FIG. 1A and FIG. 1B, the imaging device 100 is a digital still camera that mainly shoots still images. Note that the imaging device 100 may shoot moving images. The imaging device 100 includes, for example, a main body section 1, and a lens section 2 (refer to FIG. 1B) that is detachably mounted substantially in the middle of a front surface 1F of the main body section 1. The lens section 2 includes one or more imaging lenses inside a lens barrel. The lens section 2 mounted on the main body section 1 is removable from the main body section 1, for example, by pressing down a lens section release button 2A provided on the front surface 1F.

The main body section 1 includes various electronic components inside a housing 10 having a substantially rectangular parallelepiped shape. The housing 10 of the main body section 1 mainly includes, for example, a highly rigid metal material such as a magnesium alloy. The housing 10 of the main body section 1 has a right side surface 1R, a left side surface 1L, a back surface 1B, and an upper surface 1U in addition to the front surface 1F.

A grip 3 for grasping by a user of the imaging device 100 with his right hand is provided adjacent to the lens section 2 on the front surface 1F. The grip 3 is formed integrally with the main body section 1, for example. A power source operation lever 4 and a release button 5 are provided on an upper portion of the grip 3.

A card slot where a memory card is to be inserted is provided inside the housing 10, and an opening/closing cover 6 that covers an opening of the card slot is provided on the right side surface 1R. Further, strap attaching sections 7 (7R and 7L), which includes metal, for attaching a shoulder strap are respectively provided on upper portions of the right side surface 1R and the left side surface 1L.

The back surface 1B of the main body section 1 is provided with a control wheel 9 and the like in addition to a display panel 8. The display panel 8 is a display device that is able to display, in addition to a shot image, for example, image shooting conditions upon shooting the image, setting conditions of the imaging device 100, an operation menu, and the like. As the display panel 8, for example, a liquid crystal panel, an organic EL (electro-luminescence) panel, or the like is applicable. The control wheel 9 is, for example, an operation section used to select a setting condition or an operation menu displayed on the display panel 8.

For example, the upper surface 1U of the main body section 1 is provided with a mode dial 11, an exposure compensation dial 12, a drive mode dial 13, an optical viewfinder 14, and the like.

The optical viewfinder 14 incorporates an optical prism, which makes it possible to reflect light having passed through the lens section 2 by a mirror to project a subject on a finder screen, thereby allowing a user to directly see and check the subject.

The mode dial 11 is an operation section for selecting one image shooting mode from among a plurality of image shooting modes in the imaging device 100, and is held rotatably with respect to the main body section 1. Examples of the image shooting modes include a fully automatic setting mode, a partially automatic setting mode, a diaphragm priority mode, a shutter speed priority mode, a manual exposure setting mode, and the like. The fully automatic setting mode is an image shooting mode in which all condition settings relating to image shooting are automatically performed by the imaging device 100, not by a command from the user. The partially automatic setting mode is, for example, an image shooting mode in which exposure settings, i.e., a shutter speed setting and an aperture setting are performed automatically by the imaging device 100, and settings other than the exposure settings are performed manually by the user. The diaphragm priority mode is an image shooting mode in which the user manually sets an aperture and the imaging device 100 automatically sets shutter speed. The shutter speed priority mode is an image shooting mode in which the user manually sets shutter speed and the imaging device 100 automatically sets an aperture. The manual exposure setting mode is an image shooting mode in which the user manually performs exposure settings. In the imaging device 100, the mode dial 11 doubles as an antenna 110 (to be described later) that performs communication with an external device. The detailed configuration of the mode dial 11 is described later.

The exposure compensation dial 12 is an adjustment mechanism that corrects exposure upon image shooting in the imaging device 100. The exposure compensation dial 12 is held rotatably with respective to the main body section 1. Rotating the exposure compensation dial 12 makes it possible to compensate exposure, with respect to an exposure reference value set by auto exposure, to an overexposure side to make the entirety of an image brighter, or to an underexposure side to make the entirety of the image darker.

The drive mode dial 13 is an operation section that sets how an image shooting operation is to be performed in a case where the release button 5 is pressed down once. In the imaging device 100, the drive mode dial 13 enables switching among a normal image shooting mode, a continuous image shooting mode, and a self-timer image shooting mode. The normal image shooting mode is a drive mode in which one still image is acquired every time the release button 5 is pressed down once. The continuous image shooting mode is a drive mode in which still images are continuously acquired while the release button 5 is held down. The self-timer image shooting mode is a drive mode in which a still image is acquired after a predetermined time has elapsed since the release button 5 was pressed down.

[1.2 Inner Configuration of Main Body Section 1]

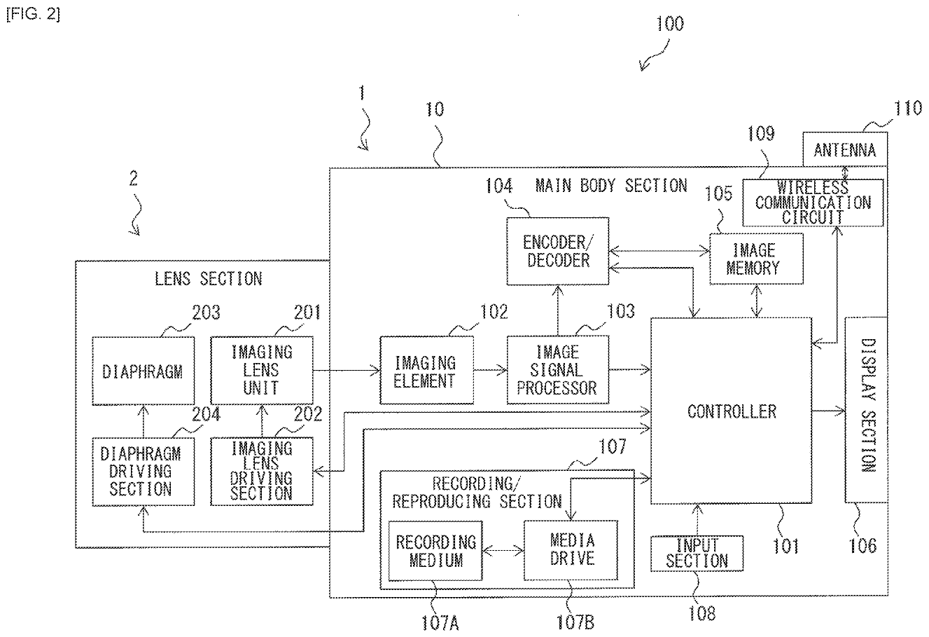

FIG. 2 is a block diagram illustrating an inner configuration example in the imaging device 100. As illustrated in FIG. 2, a controller 101, an imaging element 102, an image signal processor 103, an encoder/decoder 104, an image memory 105, a display section 106, a recording/reproducing section 107, an input section 108, a wireless communication circuit 109, and the antenna 110 are provided inside the housing 10 of the main body section 1. In addition, an imaging lens unit 201, an imaging lens driving section 202, a diaphragm 203, and a diaphragm driving section 204 are provided inside the lens section 2.

The controller 101 includes, for example, a CPU (Central Processing Unit), a RAM (Random Access Memory), a ROM (Read-Only Memory), and the like. The ROM stores programs that are read and operated by the CPU. The RAM is used as a work memory of the CPU. The CPU controls the entire imaging device 100 by executing various types of processing in accordance with the programs stored in the ROM and issuing commands

The imaging element 102 forms an image of a subject on a light reception surface through the imaging lens unit 201, and performs photoelectric conversion to generate an electrical signal. As the imaging element 102, for example, a CCD (Charge Coupled Device), a CMOS (Complementary Metal Oxide Semiconductor) image sensor, or the like is used.

The image signal processor 103 performs, on shot image data acquired by the imaging element 102, various types of image signal processing, e.g., gradation correction processing, shading correction processing, high-frequency correction (contour correction) processing, image stabilization processing, or the like.

The encoder/decoder 104 performs compression processing on shot image data having been subjected to image signal processing by the image signal processor 103, and decompression processing on compressed shot image data. For still images, for example, compression processing and decompression processing according to a predetermined still image format such as a JPEG (Joint Photographic Experts Group) format are performed. Meanwhile, for moving images, compression processing and decompression processing according to a predetermined moving image format such as an MPEG (Moving Picture Experts Group) format are performed.

The image memory 105 is a buffer memory including a volatile memory, e.g., a DRAM (Dynamic Random Access Memory), and is a device that temporarily stores image data having been subjected to predetermined processing by the image signal processor 103 and the encoder/decoder 104.

The display section 106 is a display device that displays an image based on shot image data, and an image of a subject formed on a light reception surface of the imaging element 102 through the imaging lens unit 201, and corresponds to the display panel 8 described above.

The recording/reproducing section 107 includes a recording medium 107A and a media drive 107B. Examples of the recording medium 107A include a memory card including a semiconductor memory such as a flash memory, or a magnetic disk, an optical disk, a magneto-optical disk, and the like. The media drive 107B performs recording of compressed shot image data in the still image format or the moving image format acquired by the encoder/decoder 104 in the recording medium 107A and reproduction (reading) of various types of data of the compressed shot image data recorded in the recording medium 107A on the basis of control by the controller 101.

The input section 108 is a portion where various operation inputs to be performed on the imaging device 100 by a user is performed. For example, a touch panel section included in the display panel 8, and the power source operation lever 4, the release button 5, the control wheel 9, the mode dial 11, the exposure compensation dial 12, the drive mode dial 13, and the like provided in the main body section 1 correspond to the input section 108. The input section 108 detects an input operation by the user and transmits information (operation input information) corresponding to the input operation to the controller 101.

The wireless communication circuit 109 is coupled to the controller 101, and performs various types of processing, such as modulation processing, necessary for wireless transmission on various types of information such as shot image data inputted from the controller 101.

The antenna 110 is coupled to the wireless communication circuit 109, and is a transmitter-receiver for wirelessly transmitting, to an external device, various types of information having been subjected to modulation processing and the like in the wireless communication circuit 109 and wirelessly receiving various types of information from the external device. In the imaging device 100, for example, the mode dial 11 is used as the antenna 110. That is, the mode dial 11 serves as both an operation section for selecting an image shooting mode in the imaging device 100 and the antenna 110 that transmits and receives various types of information to and from another electronic device other than the imaging device 100.

[1.3 Inner Configuration of Lens Section 2]

A combination of the imaging element 102, the image signal processor 103, and the controller 101 in the main body section 1, and the imaging lens unit 201, the imaging lens driving section 202, the diaphragm 203, and the diaphragm driving section 204 in the lens section 2 is a specific example corresponding to an imaging section of the present disclosure.

The imaging lens unit 201 includes one or more lenses in a lens barrel, and is configured to enable focusing and zooming by the imaging lens driving section 202. The imaging lens driving section 202 performs focusing, zooming, and the like in the imaging lens unit 201 on the basis of control by the controller 101.

The diaphragm 203 is provided, for example, inside the lens barrel in the imaging lens unit 201, and is configured to enable adjustment of an aperture by the diaphragm driving section 204. The diaphragm driving section 204 performs adjustment of the aperture by driving the diaphragm 203 on the basis of control by the controller 101.

[1.4 Detailed Configuration of Mode Dial 11]

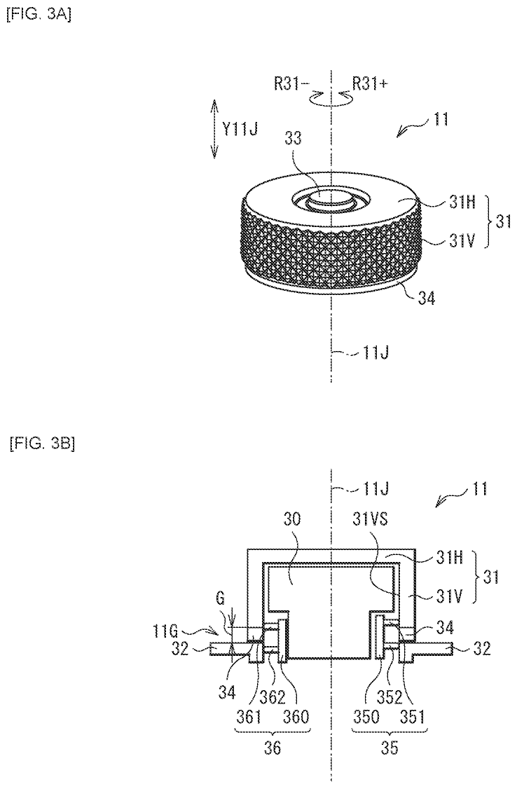

Next, description is given of a detailed configuration of the mode dial 11 with reference to FIGS. 3A to 3D. FIG. 3A is an enlarged perspective view of an appearance of the mode dial 11. FIG. 3B is a schematic cross-sectional view of an inner configuration of the mode dial 11. FIG. 3C is a conceptual diagram illustrating a configuration of the mode dial 11 that is developed on a plane. Further, FIG. 3D is a schematic view of the mode dial 11 as viewed from above.

As illustrated in FIG. 3A and FIG. 3B, the mode dial 11 includes a support post 30 that contains various types of electronic components, a rotary dial 31 that covers the support post 30, a base 32 that is fixed to the upper surface 1U of the main body section 1, and a lock button 33. As described above, the mode dial 11 doubles as the antenna 110 that performs communication with an external device. Accordingly, the rotary dial 31 and the base 32 are provided in the housing 10 to be exposed on outside of the housing 10.

The rotary dial 31 is a rotating body that is provided with respect to the support post 30, the base 32, and the like to be rotatable about a rotation axis 11J as a rotational center in both a rotation direction R31+ and a rotation direction R31−. It is to be noted that in the following description, the rotation direction R31+ and the rotation direction R31− may be collectively referred to as a rotation direction R31. The user is able to select any image shooting mode by rotating the rotary dial 31. Further, the user is able to lock the rotary dial 31 at a predetermined position by pressing down the lock button 33.

The rotary dial 31 mainly includes a metal material such as a magnesium alloy, and includes a horizontal portion 31H that covers an upper surface of the support post 30 and extends in a plane orthogonal to the rotation axis 11J, and a substantially cylindrical vertical portion 31V with the rotation axis 11J as a central axis. Selectable image shooting modes are displayed on the horizontal portion 31H. The vertical portion 31V extends along the rotation direction R31 to surround the rotation axis 11J. It is sufficient if a rough portion is provided on an outer surface of the vertical portion 31V to increase frictional resistance with respect to a finger surface of the user.

The base 32 mainly includes a metal material such as a magnesium alloy similarly to the rotary dial 31. It is to be noted that the base 32 may be configured integrally with an exterior member of the main body section 1. That is, the base 32 may configure a portion of the housing 10 of the main body section 1. The base 32 is an annular-shaped metal member that extends along the rotation direction R31 to surround the rotation axis 11J. The rotary dial 31 and the base 32 are opposed to each other with a gap 11G having a predetermined width G interposed therebetween in a direction along the rotation axis 11J orthogonal to the rotation direction R31 (which is referred to as a rotation axis direction Y11J). The rotary dial 31 rotates to the rotation direction R31 while maintaining the width G of the gap 11G. It is to be noted that an annular-shaped insulating member 34 is inserted into the gap 11G to prevent water or the like from entering the inside of the rotary dial 31. The insulating member 34 includes a resin material such as an ABS (acrylonitrile butadiene styrene) resin or polycarbonate having high moisture-proof property.

As illustrated in FIGS. 3B to 3D, the mode dial 11 further includes a first coupling section 35 and a second coupling section 36. The first coupling section 35 is an electrically conductive member that couples the rotary dial 31 and the base 32 to each other in the rotation axis direction Y11J at a first position P1 in the rotation direction R31. The second coupling section 36 is an electrically conductive member that couples the rotary dial 31 and the base 32 to each other in the rotation axis direction Y11J at a second position P2 in the rotation direction R31. The second position P2 is a position away from the first position P1 in the rotation direction R31. Here, a distance between the first position P1 and the second position P2 in the rotation direction R31 is λ/2 that is equal to a half of a used wavelength λ in the antenna 110 (refer to FIG. 3C and FIG. 3D).

As illustrated in FIG. 3B, the first coupling section 35 includes a substrate 350, and a rotary dial contact terminal 351 and a base contact terminal 352 that are each provided on the substrate 350 in a standing manner. Similarly, the second coupling section 36 includes a substrate 360, and a rotary dial contact terminal 361 and a base contact terminal 362 that are each provided on the substrate 360 in a standing manner. The substrates 350 and 360 are, for example, flexible wiring printed boards. The rotary dial contact terminals 351 and 361, and the base contact terminal 352 and 362 each include an electrically conductive material.

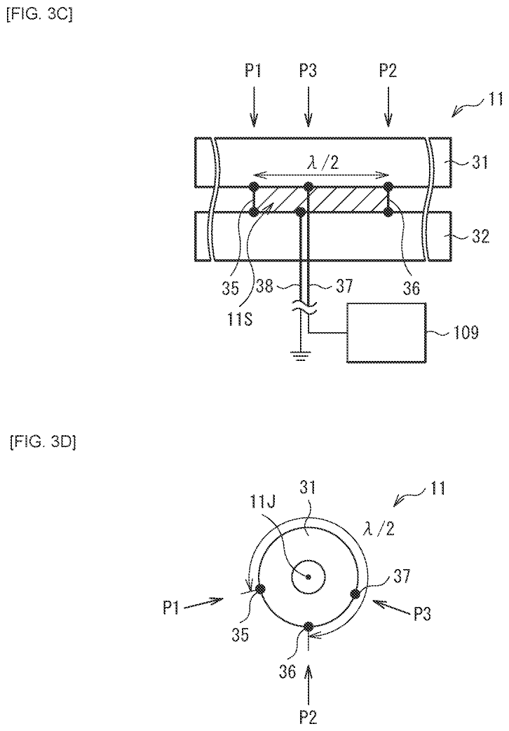

FIG. 4 is an enlarged cross-sectional view of a vicinity of the rotary dial contact terminal 351 in the first coupling section 35. As illustrated in FIG. 4, the rotary dial contact terminal 351 includes, for example, a spring member 41 and a hook 42. The spring member 41 includes a fixed portion 411 that is fixed to the substrate 350, a protruding portion 412 that is located on a side opposite to the substrate with the fixed portion 411 interposed therebetween, and a tip portion 413. The spring member 41 develops a biasing force in a direction where the fixed portion 411 and the tip portion 413 are separated from each other. Accordingly, the protruding portion 412 is constantly in contact with an inner surface 31VS of the vertical portion 31V of the rotary dial 31 by the biasing force of the spring member 41. It is to be noted that the hook 42 locks both the fixed portion 411 and the tip portion 413 to prevent a distance therebetween from being excessively widened. The protruding portion 412 slides on the inner surface 31VS during rotational movement of the rotary dial 31. The spring member 41 brings the protruding portion 412 into contact with the inner surface 31VS and applies a biasing force indicated by an arrow Y41 to the inner surface 31VS; therefore, electrical continuity between the rotary dial contact terminal 351 and the rotary dial 31 is ensured even in a case where wear of the inner surface 31VS or the protruding portion 412 occurs due to the rotational movement of the rotary dial 31. It is to be noted the rotary dial contact terminal 361 in the second coupling section 36 has a configuration similar to that of the rotary dial contact terminal 351.

As illustrated in FIG. 3C and FIG. 3D, the mode dial 11 further includes a feed line 37 as a first signal line and a grounding line 38 as a second signal line. The feed line 37 is coupled to the rotary dial 31 at a third position P3 between the first position P1 and the second position P2 in the rotation direction R31, and is configured to supply an RF signal to the rotary dial 31. The feed line 37 includes, for example, a coaxial cable having a characteristic impedance of about 50 ohms or the like, and has a first end coupled to the rotary dial 31 and a second end coupled to the wireless communication circuit 109 (refer to FIG. 2). The grounding line 38 has a first end coupled to the base 32 and a second end grounded. It is to be noted that in the mode dial 11, the grounding line 38 may be coupled to the rotary dial 31 at the third position P3, and the feed line 37 may be coupled to the base 32 to supply an RF signal to the base 32. In addition, in FIG. 3A and FIG. 3B, the feed line 37 and the grounding line 38 are not illustrated.

The mode dial 11 also serves as a so-called slot antenna having the configuration described above. Specifically, as illustrated in FIG. 3C, the mode dial 11 has a rectangular slot 11C having the length λ/2 and the width G that is formed by four electrically conductive members, i.e., the rotary dial 31, the base 32, the first coupling section 35, and the second coupling section 36. In the mode dial 11 as the slot antenna, the slot 11S described above is used as a radiation element. It is to be noted that as the third position P3 where the feed line 37 is coupled to the rotary dial 31, an appropriate position is selected where impedance matching is achieved between the first position P1 and the second position P2 that define the length λ/2 of the slot 11S.

[1.5 Effects of Imaging Device 100]

As described above, in the imaging device 100 according to the present embodiment, the mode dial 11 is used as an operation section that selects an image shooting mode, and is also used as the antenna 110. This makes it possible to achieve a simpler configuration as compared with a case where an antenna is provided as a component different from an operation section such as the mode dial 11, and is advantageous in downsizing. In particular, in the mode dial 11, the rotary dial 31 is rotatably provided with respect to the base 32; therefore, the gap 11G having a fixed width G is present between the rotary dial 31 and the base 32. In the imaging device 100, the gap 11G is used to form the slot 11S having highly accurate dimensions, thereby implementing a slot antenna that is able to perform desired wireless communication.

In addition, in the imaging device 100, the first coupling section 35 and the second coupling section 36 are each provided to cause a circumferential distance between the first position P1 and the second position P2 to become the length λ/2 in accordance with a desired used wavelength λ. That is, adjusting first position P1 and second position P2 makes it possible to select the used wavelength 2 to be used in wireless communication. No design change in appearance is necessary to change the first position P1 and the second position P2. Accordingly, it is not necessary to change design of the mode dial 11 for the used wavelength 2, and flexibility in designing the mode dial 11 is improved.

In addition, in the imaging device 100 according to the present embodiment, the mode dial 11 located at an outermost portion of the main body section 1 is used as an antenna, which makes it possible to form an exterior portion such as an operation section other than the housing 10 and the mode dial 11 by using a metal material. In contrast, in a case where the antenna is provided inside the housing, it is difficult to use a metal material that shields radio waves for the housing, an exterior component, and the like, and it is desirable for the housing and the exterior component to include a resin material. Therefore, according to the imaging device 100, it is possible to form the exterior portion by using a highly rigid metal material, which makes it possible to achieve an improvement in texture and an improvement in durability, as compared with a case where the exterior portion is formed by using a resin material or the like.

It is to be noted that in a digital camera 1 described in PTL 1 described above, as illustrated in FIG. 2 and the like, antenna members 5a and 5b are disposed inside selection dials 3a and 4a. However, in a case where the selection dials 3a and 4a include a metal material, radio waves to the antenna members 5a and 5b are shielded, and it is not therefore practically possible for the selection dials 3a and 4a to include a metal material.

In addition, in an electronic camera 10 described in PTL 2 described above, a metal component originally existing in an exterior portion is also used as an antenna. However, in the electronic camera 10 in PTL 2, in a case where there is no metal component having dimensions corresponding to a wavelength to be used in wireless communication, it is not possible to use the metal component as an antenna. In a case where the dimensions of the metal component are changed in accordance with the wavelength to be used in wireless communication, it is difficult to select design optimized to obtain an original function of the metal component. That is, there is no choice but to sacrifice the design of the metal component in order to exhibit a function as a antenna.

In this respect, in the imaging device 100 according to the present embodiment, it is possible to use the mode dial 11 as an antenna without restricting flexibility in designing the mode dial 11. In addition to this, it is possible to form an exterior portion such as the housing 10 by using a metal material having superior texture and superior durability.

Further, in the imaging device 100 according to the present embodiment, the rotary dial contact terminals 351 and 361 each are biased to come into contact with the inner surface 31VS of the rotary dial 31. Accordingly, electrical continuity between each of the rotary dial contact terminals 351 and 361 and the rotary dial 31 is ensured, and a stable operation as the antenna 110 is ensured.

<2. Modification Examples>

Although the present disclosure has been described with reference to the embodiment, the present disclosure is not limited to the embodiment described above, and may be modified in a variety of ways.

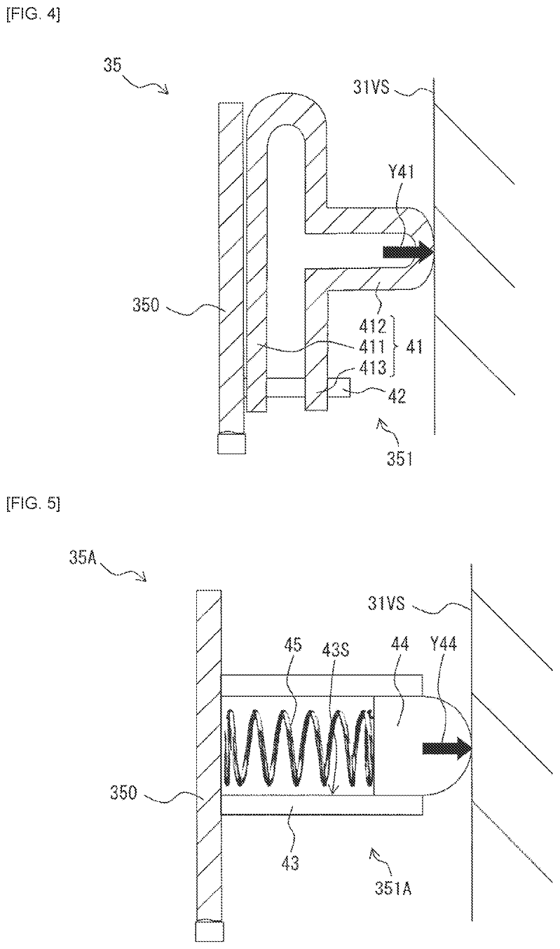

For example, in the embodiment described above, the first coupling section includes the rotary dial contact terminal 351 including the plate spring member 41 as illustrated in FIG. 4; however, the first coupling section and the second coupling section of the present disclosure are not limited thereto. The first coupling section and the second coupling section of the present disclosure may include, for example, a rotary dial contact terminal 351A including a coil spring 45 as with a first coupling section 35A as a first modification example illustrated in FIG. 5. The rotary dial contact terminal 351A includes, for example, a tubular member 43 that is provided on the substrate 350 in a standing manner, a tip member 44 that is provided movably along an inner surface 43S of the tubular member 43, and the coil spring 45 that applies, to the tip member 44, a biasing force toward the inner surface 31VS of the vertical portion 31V. The tip member 44 slides on the inner surface 31VS during rotational movement of the rotary dial 31. Thus, in the first coupling section 35 as the first modification example, the coil spring 45 brings the tip member 44 into contact with the inner surface 31VS, and applies a biasing force indicated by an arrow Y44 to the inner surface 31VS. Accordingly, electrical continuity between the rotary dial contact terminal 351A and the rotary dial 31 is ensured even in a case where wear of the inner surface 31VS or the tip member 44 occurs due to the rotational movement of the rotary dial 31.

In addition, in the embodiment described above, the mode dial 11 as an operation section that selects an image shooting mode is also used as the antenna 110. However, in the imaging device 100 of the present disclosure, for example, any other component such as the exposure compensation dial 12 and the drive mode dial 13 may be used as the antenna 110. In addition, a component that does not have a rotating body, such as the release button 5, may be used as the antenna 110. That is, a component including two metal members that is opposed to each other with a predetermined gap interposed therebetween has a possibility of being used as the antenna 110.

In addition, in the embodiment described above, description has been given by exemplifying a case where the imaging device 100 is a single-lens reflex camera incorporating an optical viewfinder or the like; however, the present technology is not limited thereto, and is applicable to a mirrorless camera. The mirrorless camera does not include a mirror, an optical prism, and an optical viewfinder, and has a configuration in which light having passed through a lens section enters an imaging element as it is. Accordingly, in the mirrorless camera, an electronic viewfinder is incorporated in place of the optical viewfinder, and a user is able to visually recognize digitized image data displayed on the electronic viewfinder.

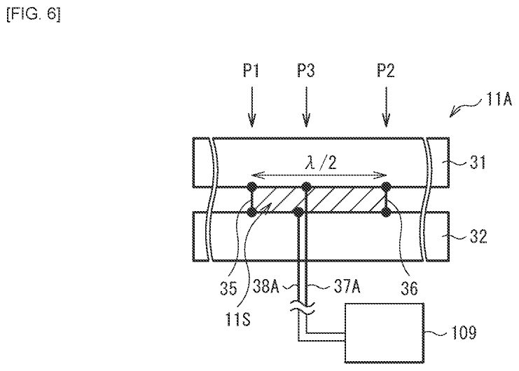

In addition, in the embodiment described above, description has been given of an unbalanced power feeding state in which an RF signal is supplied to the rotary dial 31 as a first metal member and the base 32 as a second metal member is grounded in a case where the mode dial 11 is used as the antenna 110. However, the present disclosure is not limited thereto. That is, as in a mode dial 11A as a second modification example illustrated in FIG. 6, a configuration may be employed in which balanced power feeding is performed. In the balanced power feeding, a first RF signal (RF+) is supplied to the rotary dial 31 by a feed line 37A, and a second RF signal (RF−) is supplied to the base 32 by a feed line 38A.

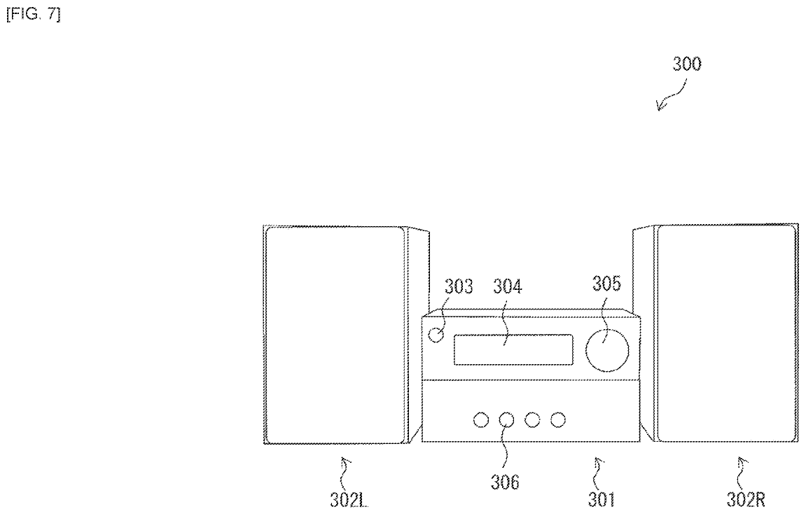

In addition, the electronic device of the present disclosure is not limited to the imaging device described in the above embodiment. The electronic device of the present disclosure may be, for example, an audio device 300 as illustrated in FIG. 7. The audio device 300 includes, for example, a main body section 301 and a pair of speaker sections 302L and 302R. A power button 303, a display section 304, a volume control dial 305, an operation mode selection button 306, and the like are provided in an exterior portion of the main body section 301. Here, for example, the volume control dial 305 has a configuration similar to that of the mode dial 11 in the imaging device 100 according to the embodiment described above. That is, the volume control dial 305 serves as both an operation section that adjusts a sound volume and an antenna that transmits and receives signals to and from an external device.

As described above, according to the electronic device as the embodiment of the present disclosure, for example, a structure such as a housing is used as a second metal member and an accessory such as a component attached to the housing is used as a first metal member, which makes it possible to perform wireless communication while having a simpler configuration.

It is to be noted that effects of the present disclosure are not limited thereto, and may be any of effects described below. In addition, the present technology may have the following configurations.

(1)

An electronic device including an antenna, the antenna including:

a first metal member that extends in a first direction;

a second metal member that extends in the first direction, and is opposed to the first metal member in a second direction with a gap interposed therebetween, the second direction being orthogonal to the first direction;

a first electrical conductor that couples the first metal member and the second metal member to each other in the second direction at a first position in the first direction;

a second electrical conductor that couples the first metal member and the second metal member to each other in the second direction at a second position away from the first position in the first direction;

a first signal line that is coupled to the first metal member at a third position between the first position and the second position in the first direction; and

a second signal line that is coupled to the second metal member.

(2)

The electronic device according to (1), further including a housing, in which

the antenna is provided in the housing to expose the first metal member and the second metal member on outside of the housing.

(3)

The electronic device according to (2), in which the second metal member configures a portion of the housing.

(4)

The electronic device according to any one of (1) to (3), in which a distance between the first position and the second position in the first direction is a length equal to a half of a used wavelength in the antenna.

(5)

The electronic device according to any one of (1) to (4), in which

the first metal member includes a rotating body that rotates to the first direction with a rotation axis along the second direction as a center while maintaining the gap, and

the first electrical conductor and the second electrical conductor respectively include a first contact terminal and a second contact terminal that are in contact with a surface of the first metal member.

(6)

The electronic device according to (5), in which each of the first contact terminal and the second contact terminal is biased to come into contact with the surface of the first metal member.

(7)

The electronic device according to any one of (1) to (6), in which the antenna further includes an insulating member that is provided to fill in the gap.

(8)

The electronic device according to any one of (1) to (7), further including an imaging section that shoots an image, in which

the first metal member includes a rotation body that selects an image shooting mode of the imaging section by rotating to the first direction with a rotation axis along the second direction as a center while maintaining the gap.

This application claims the benefits of Japanese Priority Patent Application JP2019-41491 filed with the Japan Patent Office on Mar. 7, 2019, the entire contents of which are incorporated herein by reference.

It should be understood that those skilled in the art could conceive various modifications, combinations, sub-combinations, and alterations depending on design requirements and other factors, insofar as they are within the scope of the appended claims or the equivalents thereof.

1. An electronic device comprising an antenna, the antenna including:
a first metal member that extends in a first direction;
a second metal member that extends in the first direction, and is opposed to the first metal member in a second direction with a gap interposed therebetween, the second direction being orthogonal to the first direction;
a first electrical conductor that couples the first metal member and the second metal member to each other in the second direction at a first position in the first direction;
a second electrical conductor that couples the first metal member and the second metal member to each other in the second direction at a second position away from the first position in the first direction;
a first signal line that is coupled to the first metal member at a third position between the first position and the second position in the first direction; and
a second signal line that is coupled to the second metal member.

2. The electronic device according to claim 1, further comprising a housing, wherein
the antenna is provided in the housing to expose the first metal member and the second metal member on outside of the housing.

3. The electronic device according to claim 2, wherein the second metal member configures a portion of the housing.

4. The electronic device according to claim 1, wherein a distance between the first position and the second position in the first direction is a length equal to a half of a used wavelength in the antenna.

5. The electronic device according to claim 1, wherein
the first metal member comprises a rotating body that rotates to the first direction with a rotation axis along the second direction as a center while maintaining the gap, and
the first electrical conductor and the second electrical conductor respectively include a first contact terminal and a second contact terminal that are in contact with a surface of the first metal member.

6. The electronic device according to claim 5, wherein each of the first contact terminal and the second contact terminal is biased to come into contact with the surface of the first metal member.

7. The electronic device according to claim 1, wherein the antenna further includes an insulating member that is provided to fill in the gap.

8. The electronic device according to claim 1, further comprising an imaging section that shoots an image, wherein
the first metal member comprises a rotation body that selects an image shooting mode of the imaging section by rotating to the first direction with a rotation axis along the second direction as a center while maintaining the gap.
